(19) United States
(12) Patent Application Publication
(10) Pub. No.: US 2013/0227663 A1
(43) Pub. Date: Aug. 29, 2013

(54) METHOD, A SYSTEM AND A NETWORK ELEMENT FOR IMS CONTROL LAYER AUTHENTICATION FROM EXTERNAL DOMAINS

(71) Applicant: Alejandro Cadenas Gonzalez, Madrid (ES)

(72) Inventor: Alejandro Cadenas Gonzalez, Madrid (ES)

(73) Assignee: TELEFONICA S.A., Madrid (ES)

(21) Appl. No.: 13/878,347

(22) PCT Filed: Jun. 8, 2011
(86) PCT No.: PCT/EP2011/002813

§ 371 Date: May 13, 2013

Related U.S. Application Data
(60) Provisional application No. 61/391,278, filed on Oct. 8, 2010.

(51) Int. Cl. H04L 29/06

(52) U.S. Cl. CPC H04L 63/08
USPC 726/6

(57) ABSTRACT

The method comprises: i) obtaining, an authentication registrar (S-CSCF) of a IMS control layer, two sets of IMS credentials for a user: a first set from a user equipment (UE) and a second set from a Home Server Subscriber, or HSS (100); and ii) said authentication registrar (S-CSCF) comparing said first and second sets of IMS credentials, and depending on the result of said comparison granting or denying the access of said user to IMS services. The method further comprises, before and in order to perform said steps i) and ii), obtaining, the user equipment (UE), the first set of IMS credentials from a network element (40) via a HTTP-based mechanism. The system is adapted for implementing the method, and the network element is also adapted for implementing the method and for being included in the system.

### FIELD OF THE ART

The present invention generally relates, in a first aspect, to a method for IMS control layer authentication from external domains, and more particularly to a method comprising providing a user equipment that does not have the required IMS credentials configured, with a set of IMS credentials via a HTTP-based mechanism to allow it to register to a IMS control layer.

A second aspect of the invention relates to a system for IMS control layer authentication from external domains adapted for implementing the method of the first aspect.

A third aspect of the invention concerns to a network element for IMS control layer authentication from external domains adapted for implementing the method of the first aspect, and to be included in the system as per the second aspect.

### Prior State of the Art

The access of user agents into the IMS control layer is based on SIP protocol. IMS is a standard that has been developed to define the control and integration of multimedia services and devices in a core, packet-switched networks. In particular, IMS architecture defined a set of logical functions that use the SIP protocol (defined by IETF, RFC 3261).

SIP established communication sessions in an all-IP network. A “session” may be, for example, a one-to-one voice call or a more complex interaction, such as one-to-many conference call involving multimedia services. SIP may also be used to facilitate voice over IP (VoIP) services, in which voice is transported in IP data packets that are re-assembled and converted into an audio signal for the recipient.

IMS may also be characterized as a standardized way to connect IP devices and networks using SIP.

In order to authenticate SIP User Agents into the IMS control layer, the user agent sends a SIP REGISTER method to the P-CSCF in order to be routed to the SIP registrar (the S-CSCF). The S-CSCF, when receives the SIP REGISTER, queries the HSS (Home Subscriber Server) to get the Authentication vector for the specific user. The whole signalling dialogue is detailed in 3GPP TS 23.228.

In order to be fully and properly authenticated, the user agent needs to have an IMPU (public) and IMPI (private) both at the user agent and at the HSS. In addition, different Keys to perform the authentication challenge are also stored in both sides (user agent and HSS). The authentication information stored in the HSS is as follows:
Random Challenge (RAND)
Expected Response (XRES)
Cipher Key (CK)
Integrity Key (IK)
Authentication Token (AUTN)

These parameters form a quintuplet vector used for user authentication, data confidentiality and data integrity as defined in 3GPP TS 33.102.

If the user agent does not have this information will not be able to create a proper Authentication Vector to respond to the Authentication Challenge created by the S-CSCF that is depicted in FIG. 1, extracted from 3GPP TS 33.203.

In order to get the Authentication vector, the Cx interface is used. This interface is established between the HSS and the S-CSCF and I-CSCF. The Authentication vector is requested by the S-CSCF via the Cx interface. The I-CSCF requests to the HSS the specific S-CSCF to which the registration request should be sent to.

The protocol used on interface Cx is DIAMETER, defined in IETF RFC 3588 “Diameter Base Protocol”. The messages used by the S-CSCF to request the Authentication vectors are MAR (Multimedia Authentication Request), and the HSS will respond with the MAA (Multimedia Authentication Answer). Examples of such messages are as follows:

| | |
|---|---|
| <MAR> : : = | < Diameter Header: ddd, REQ, PXY > |
| | < Session-Id > |
| | { Auth-Application-Id } |
| | { Auth-Session-State } |
| | { Origin-Host } |
| | { Origin-Realm } |
| | { Destination-Realm } |
| | { SIP-AOR } |
| | { SIP-Method } |
| | [ Destination-Host ] |
| | [ User-Name ] |
| | [ SIP-Server-URI ] |
| | [ SIP-Number-Auth-Items ] |
| | [ SIP-Auth-Data-Item ] |
| * | [ Proxy-Info ] |
| * | [ Route-Record ] |
| * | [ AVP ] |
| <MAA> : : = | < Diameter Header: ddd, PXY > |
| | < Session-Id > |
| | { Auth-Application-Id } |
| | { Result-Code } |
| | { Auth-Session-State } |
| | { Origin-Host } |
| | { Origin-Realm } |
| | { User-Name ) |
| | [ SIP-AOR ] |
| | [ SIP-Number-Auth-Items ] |
| * | [ SIP-Auth-Data-Item ] |
| | [ Authorization-Lifetime ] |
| | [ Auth-Grace-Period ] |
| | [ Redirect-Host ] |
| | [ Redirect-Host-Usage ] |
| | [ Redirect-Max-Cache-Time ] |
| * | [ Proxy-Info ] |
| * | [ Route-Record ] |
| * | [ AVP ] |

On the other hand, there is an authentication technology on the web domain. That is based on SAML (Security Assertion Markup Language), and is based on HTTP protocol, which is the common transport protocol in the web domain.

Security Assertion Markup Language (SAML) is an XML-based standard to exchange authentication and authorization data between security domains, that is, between an identity provider (a producer of assertions) and a service provider (a consumer of assertions).

The objective of this protocol is to get the SSO behaviour (Single Sign ON), in such a way that the user registers one single time and it is valid for any service that the user may access. Such services shall be integrated with the Identity Provider entity that is the main entity defined in the architecture. The SAML authentication diagram for SSO is depicted in FIG. 2, while the source signalling flow is depicted in FIG. 3 (Source: OASIS Security Assertion Markup Language (SAML) V2.0 Technical Overview).

The SAML protocol aims to carry the security credentials of the user for a given token generated by the service during user's request procedure. Once the user has obtained the security acceptance against the IdP (identity provider) and has the security assertion response, the user can send again the service request to the service.

Accordingly, the user will need to enter just one username/password, against the IdP, as any later security access to any other service will get access with no need to enter passwords, as the IdP has already identified the user.

Currently most of the telco operators are giving to their subscribers web identities (URIs), that can be used to access many (or all) of the web services that the telco operator offers (checking the monthly bill, modify charging and user parameters like addresses etc., data tariffs, etc.).

Such identities are managed by Identity Provider deployed by the telco operator, in such a way that the user experience is enhanced by entering the username/password just once.

So the usual is that the subscribers have a web username/password, but such credentials are not provisioned as valid IMS identities, as they should fulfil other requirements. So they are not suitable to register into the IMS control layer and access services hosted in the convergent service layer.

US2008177889 provides a way to get access to a Web Service over HTTP protocol from a user device that has been authenticated previously in the IMS control layer. The IMS acts then as an Identity provider that is checked to verify the identity of the user before the user is granted access to the web service.

US2010136970 refers to a new mechanism to register a communication device in an IMS control layer via a standard SIP protocol. In this proposal, the HSS is previously configured with the identities and credentials of the identity.

None of said patent applications have as a goal that of getting authentication into the IMS domain for entities that do not have an IMS identity.

Problems with Existing Solutions:

The main problem when accessing the IMS core domain is that the user agent shall have the full set of parameters preconfigured. These parameters are basically the IMPI, the IMPU and the secret key, required to perform the decryption of the Integrity Key and the Ciphering Key from the AUTN (or Authentication Token), and also to generate the RES to send back to the S-CSCF (that RES is compared with the XRES and if there is a matching, the registration is performed successfully).

However, deploying a full IMS identity requires a provisioning job at the HSS, which is highly resource and time consuming.

In addition, there are many services that are not deployed in the IMS service layer (connected to the X-CSCF via an ISC interface based on SIP (ISC—Integrated Services Control, Interface between the IMS control layer and the Application Server that is used by the signalling generated by the SIP user agents entering IMS domain). They are not deployed in IMS service layer because that would limit significantly the number of users that can access the service, as not all the user devices will have a SIP stack, and more importantly, not all of them will definitely have a SIP entity provisioned.

Such issues become a great trouble for the full deployment of convergent capabilities and functionalities in IMS service layer across the globe.

### DESCRIPTION OF THE INVENTION

It is necessary to offer an alternative to the state of the art which covers the gaps found therein, particularly those related to the lack of proposals which allow a user equipment that do not have an IMS identity getting authentication into the IMS domain.

This proposal aims to solve this problem and make it possible for entities with no IMS identity to register into the IMS domain.

To that end, the present invention provides, in a first aspect, a method for IMS control layer authentication from external domains, comprising

i) obtaining, an authentication registrar of a IP Multimedia Subsystem, or IMS, control layer, two sets of IMS credentials for a user: a first set from a user equipment and a second set from a Home Server Subscriber, or HSS; and

ii) said authentication registrar comparing said first and second sets of IMS credentials, and depending on the result of said comparison granting or denying the access of said user to IMS services.

On contrary to the known proposals, the method of the first aspect of the invention comprises, in a characteristic manner, before and in order to perform said steps i) and ii), obtaining, said user equipment, said first set of IMS credentials from a network element via a HTTP-based mechanism.

For a preferred embodiment, said network element is an authentication server, the method comprising validating the identity of said user by means of said authentication server via a HTTP-based authentication mechanism as a condition to provide the user with said IMS credentials, by means of said authentication server.

The method comprises, said authentication server, once the identity of said user has been validated, obtaining the first set of IMS credentials from said HSS, for an embodiment.

Other embodiments of the method of the first aspect of the invention are disclosed by claims 4 to 14 and also in a subsequent section regarding the detailed description of several embodiments.

A second aspect of the invention concerns to a system for IMS control layer authentication from external domains, comprising at least:
a user equipment;
   a HSS;
an authentication registrar of a IMS control layer; and
first communication means connecting said authentication registrar with said user equipment and with said HSS.

Said authentication registrar is intended for comparing two sets of IMS credentials for a user: a first set from a user equipment and a second set from said HSS, obtained through said communication means, and for, depending on the result of said comparison, granting or denying the access of said user to IMS services.

On contrary to known systems for IMS control layer authentication, the system of the second aspect of the invention further comprises a network element communicated, through second communication means, with said user equipment for providing it with said first set of IMS credentials via a HTTP-based mechanism.

Said user equipment, said HSS, said first and second communications means and said authentication registrar are arranged for implementing the method of the first aspect of invention according to different embodiments.

For a preferred embodiment of the system of the second aspect of the invention, said network element is an authentication server, the system comprising third communication means connecting said authentication server with said HSS for obtaining the first set of IMS credentials from said HSS.

A third aspect of the invention relates to a network element for IMS control layer authentication from external domains which comprises:
IMS communication means for communicating with an HSS for obtaining a first set of IMS credentials there;
HTTP-based communication means for communicating with a user equipment via a HTTP-based mechanism for at least providing it with said first set of IMS credentials; and
processing means for at least performing processing tasks needed for said obtaining and providing of said first set of credentials.

The network element of the third aspect of the invention is arranged for implementing the method of the first aspect and to be included in the system as per the second aspect.

### BRIEF DESCRIPTION OF THE DRAWINGS

The previous and other advantages and features will be more fully understood from the following detailed description of embodiments, with reference to the attached drawings (some of which have already been described in the Prior State of the Art section), which must be considered in an illustrative and non-limiting manner, in which:

FIG. 1 shows a conventional IMS registration process;

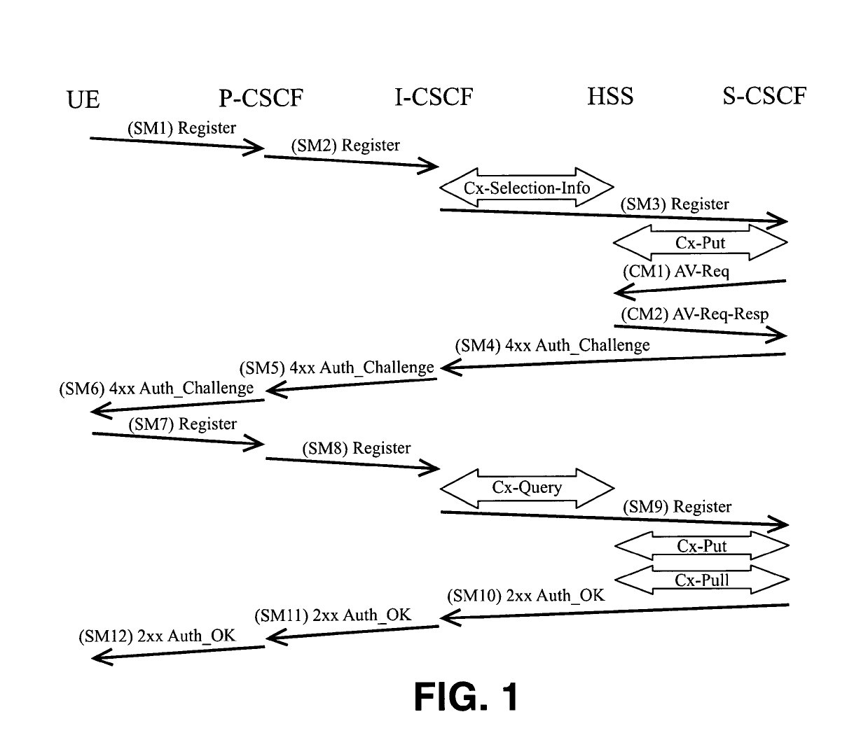

FIG. 2 shows the SAML authentication diagram for SSO;

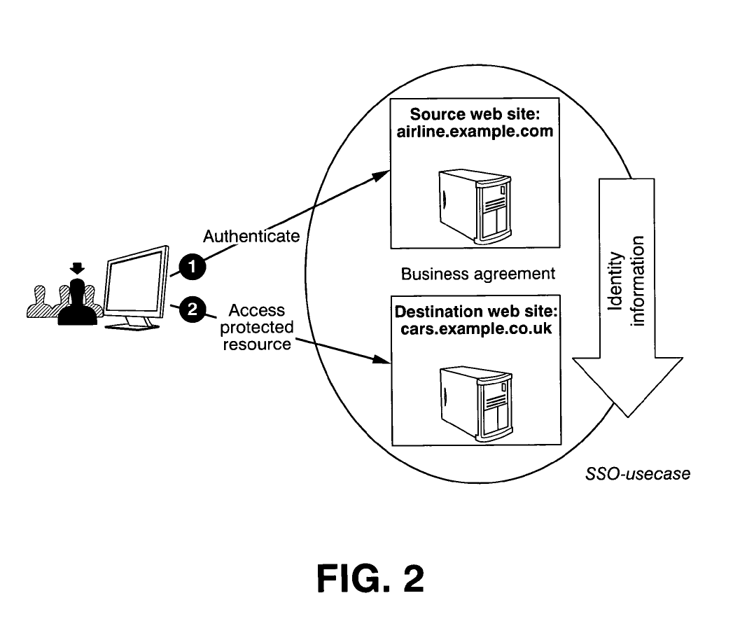

FIG. 3 shows the SAML authentication signalling flow for SSO;

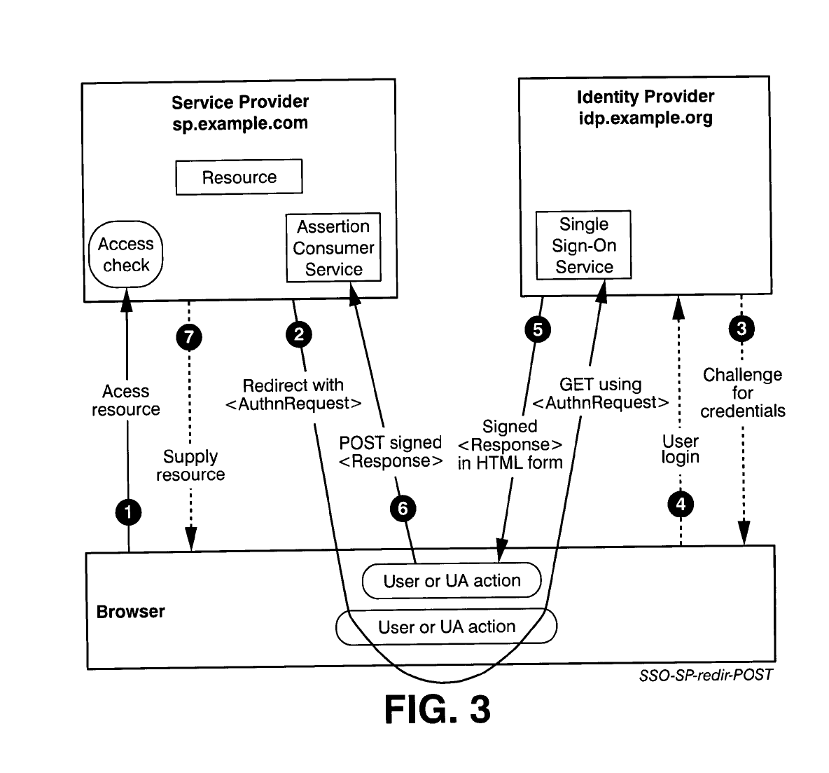

FIG. 4 schematically shows the architecture of system of the second aspect of the invention for an embodiment; and

FIG. 5 shows the signalling flow followed according to an embodiment of the method of the first aspect of the invention.

### DETAILED DESCRIPTION OF SEVERAL EMBODIMENTS

Next, a description of the invention for several embodiments will be done, referring the appended Figures.

The apparatus proposed by the third aspect of the invention is a network element and the corresponding mechanism to retrieve the proper IMS identity credentials via a HTTP-based mechanism, properly authenticated via a standard HTTP-based authentication mechanism (like for example SAML2.0).

Such network element, when integrated in the system of the second aspect and according to the method of the first aspect, will get the IMPI, IMPU and secret key from the HSS of the IMS control layer, and will securely send it to the requesting agent. The requesting user will then be able to perform a full IMS registration procedure via standard IMS mechanisms specified by 3GPP.

This proposal is designed to grant access to services located in the IMS service layer to users that are not provisioned in the HSS. So the HSS is proposed to have a pool of IMPUs and associated IMPIs, all of them with their respective secret keys to perform a complete registration. Such secret key will be updated every time an IMPI/IMPU combination is used by some user agent to register to the IMS control layer. Apart from the IMPU, IMPI and secret key, the HSS will also have the Ciphering Key (CK) and the Integrity Key (IK) also stored for each IMPI/IMPU combination.

The User Equipment initially requests the IMS credentials to a server that validates the user identity via Web mechanisms (like Identity Provider, IdP, based on SAML).

Once the user is validated, the Authentication Server gets the IMS credentials directly from the HSS. That information is sent to the user in a secure manner. Once the user equipment gets that information, it performs the IMS registration in a standard procedure.

The IMS credentials that the HSS gives to the Authentication server are extracted from a pool of identities available for such type of registration mechanisms. Once the IMPI and IMPU have been used for an IMS registration, the HSS will generate a different Secret Key for the next user that requests such type of access.

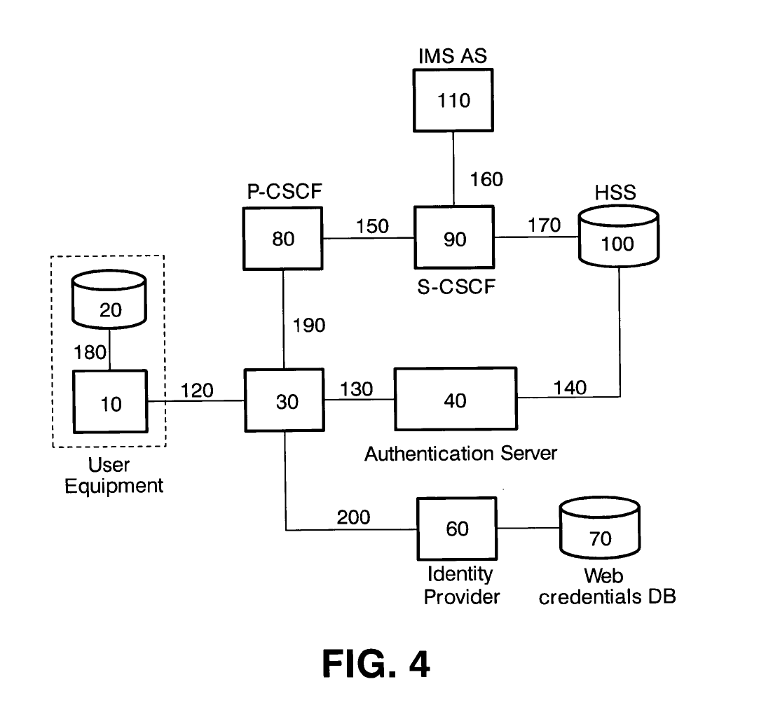

As it is shown in FIG. 4, the entities and interfaces included in the architecture of the system of the second aspect of the invention are as follows:
Communication module at the User Equipment. (10). This module is in charge of establishing and maintaining the HTTP and SIP dialogues to perform the different registration procedures as well as retrieving the proper parameters.
Internal parameter storage database at the User Equipment (20). This module is in charge of storing the user identities and the credentials required for the different registration procedures and retrieved also from them.
IP data network (30). This is the access network used by the User Equipment to access the different authentication servers and IMS network elements. The actual technology of this access network may be diverse and will depend on the transmission capabilities of the User Equipment. Some options may be wired xDSL transport technologies, or PS access through a UMTS radio access network among others.
Authentication Server Web-IMS (40). This element is an HTTP service reachable by users through the access network (30) that will interact with the HSS to get the specific parameters (IMPI, IMPU, Secret Key) to give the User Equipment. The authentication of the user in this service (40) is critical and is provided by the IdP (60) via standard web authentication mechanisms like SAML. Other mechanisms may also apply. This element is a critical part of this invention and is one of the innovative elements proposed.
Identity Provider (IdP), (60). This element is in charge of implementing the specific Web-based authentication protocol aimed to validate the User Equipment username/password before granting access to the Authentication Server (40).
Database Storage (70) of the Identity Provider. This database (often considered part of the IdP itself) keeps the web credentials (username/password) of the subscriber in order to provide a SingleSignOn functionality.
P-CSCF (Proxy-Call Session Control Function) (80). It is the entry point for all the signalling sent to the IMS control layer. The registration request will be sent to the P-CSCF via the access network (30).
S-CSCF (Serving-Call Session Control Function) (90). It is the SIP Registrar of the IMS control layer. The S-CSCF will validate the proper registration of the SIP User Agents and will be in charge of the orchestration of the SIP signalling among the different entities of the IMS Service layer and the user agents.
HSS (Home Subscriber Server) (100). This is the main subscriber information storage in the IMS domain. It stores the IMPI, IMPU, CK, IK, Secret Key as well as the subscriber profile of the subscriber (to be used when the registration is finished properly). The S-CSCF will contact the HSS in order to get the credentials to validate the registration procedure against the User Agent during the standard registration procedure (specified in 3GPP TS 24.228). In the HSS some modules are proposed, as part of the innovative elements of this patent submission. Those innovative aspects are the ones related to the internal allocation, request and delivery of pooled IMS identities.
IMS Application Server (110). This is the application server accessible through IMS control layer where the capabilities that the user is looking for are stored. These capabilities cannot be accessed if the User Equipment is not properly registered in the S-CSCF of the IMS control layer.
Interface between the UE and the Access Network (120). Its nature will depend on the communication capabilities of the User Equipment, and may go from a wired Ethernet connection in the case of a regular PC, to a cellular IP connection in the case of a mobile phone.
Interface with the Authentication Server Web-IMS (130). This interface will be HTTP-based, and will be used by the User Equipment to request the IMS identity of the pool reserved at the HSS for this type of registration. The specific protocol can be SAML, although other options may apply.
Interface between the Authentication Server Web-IMS and the HSS (140). This interface is a critical part of this patent submission and is one of the innovative elements proposed. Via this interface the Authentication Server Web-IMS will retrieve from the HSS the following parameters: IMPI, IMPU, Secret Key and eventually, P-CSCF. The P-CSCF URI is not strictly required as the standard provides mechanisms to discover the P-CSCF, but it can also be included. The protocol of this interface will depend on the HSS capabilities. The HSS will implement DIAMETER protocol to perform the queries, but it is also possible that the specific parameters required can be obtained via a HTTP/SOAP transaction (a web service dialogue). Other mechanisms with same result may also apply. However, HTTP-based interfaces are not standard for the HSS as per 3GPP, so a set of specific DIAMETER primitives are defined as part of the innovations of this invention, according to an embodiment. This is detailed later.
Interface between P-CSCF and S-CSCF (150). This interface is based on SIP protocol and is standard, defined by 3GPP.
Interface between the S-CSCF and the Application Server (160). This interface is based on SIP protocol and is standard, defined by 3GPP. This is referred as ISC interface.
Interface between the S-CSCF and the HSS (170). This interface is based on DIAMETER and is used by the S-CSCF to retrieve subscriber information during registration procedure as well as some others. It is standard and is defined by 3GPP.
Interface between the Communication module and the internal parameter storage database at the User Equipment (180). This interface is application specific and its implementation is not relevant for this invention.
Interface between the Access Network and the P-CSCF (190). This interface is the access point to the P-CSCF and is SIP based.
Interfaces between the Access Network and the IdP (200). This is the interface used to access the IdP to get access and user validation at the Authentication Server Web-IMS. It is based on HTTP, and it can be based on SAML, although other protocols may also apply, as long as they have the same functional behaviour.

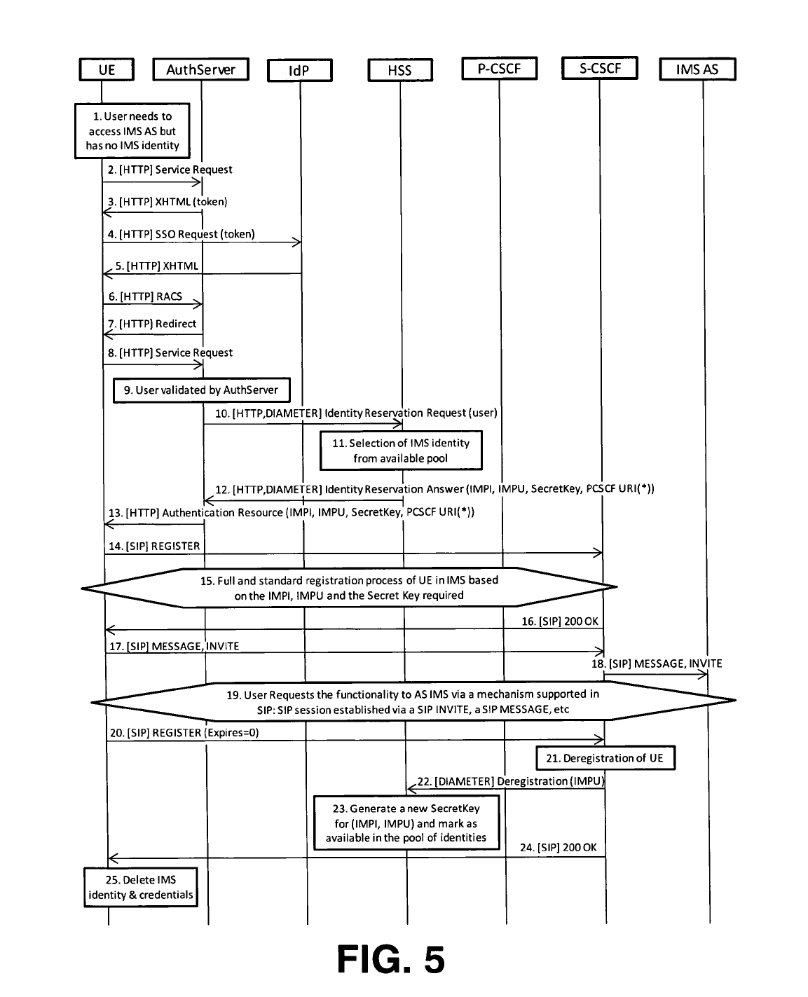

As FIG. 5 shows, the flow in real time to be followed according to an embodiment of the method of the first aspect of the invention comprises the following steps:

1. The user needs to access or has been redirected to a service provided by an AS IMS, that can only be accessed via a previous registration in the IMS control layer. In order to get IMS identity and credentials (the UE has none), the UE is referred to an Authentication Web-IMS server that will grant him the identities and credentials to register in IMS.

2. The user equipment requests the corresponding resource to the Authentication Server. The Resources requested are the IMS identity and credentials to use for a proper IMS registration.

3. The Authentication Server responds to the UE with an XHTML form that includes a token to track the transaction.

4. The UE then requests the SSO (Single Sign-On) Service at the IdP. This transaction includes the token exchanged in step 3.

5. IdP responds with an XHTML form, validating the request. This response includes a security assertion.

6. The UE sends a RACS (Request Assertion Consumer Service) to the Authentication server, including the security assertions obtained in step 5.

7. The Authentication server processes the response, creates a security context at the service provider and redirects the user agent to the target resource.

8. The UE requests the resources to the Authentication Server, after the redirection requested in step 7.

9. At this point the UE is validated at the Authentication Web-IMS server, by using the username/password available in the SSO service (IdP).

10. Once the Authentication Server validates the user, it queries the HSS for the IMS identity and credentials. That is performed via a DIAMETER Identity Reservation Request message (IRR). Specific non-standard mechanisms to retrieve the identity (non based on DIAMETER) would also fit into this functional description. This transaction is secure as it takes place in the operator security service layer.

The DIAMETER Identity Reservation Request message is NOT part of the DIAMETER standard and is proposed in this patent proposal as one of the innovative aspects that can be associated to a standard. The DIAMETER messages contain information elements or AVPs (Attribute-Value Pairs). The AVPs that the Identity Reservation Request (IRR) should contain at least are the following:

```
<IRR>::= < Diameter Header: ddd, REQ, PXY >
    < Session-Id >
    { Auth-Application-Id }
    { Auth-Session-State }
    { Origin-Host }
    { Origin-Realm }
    { Destination-Realm }
    { SIP-AOR }
    { SIP-Method }
    [ User-Name ]
    [ Web-token ]
    [ SIP-Server-URI ]
    [ SIP-Number-Auth-Items ]
    [ SIP-Auth-Data-Item ]
  * [ Proxy-Info ]
  * [ Route-Record ]
  * [ AVP ]
```

The User-Name AVP is optional and carries the name of the user requesting the identity, if that is available. The Web-Token AVP is optional and carries the unique token generated by the Authentication Server in order to uniquely identify the user during the process.

11. The HSS has a set of IMS identities (identified by IMPI and IMPU) as well as all the required parameters to allow their registration in the IMS control layer. Those identities will behave as a pool of identities that can be used on a demand basis, in order to grant IMS access to UEs that do not have preconfigured IMS identities.

When the HSS gets the request from the Authentication server, the HSS selects one of the available (not assigned) IMS identities from the pool.

12. The HSS responds to the request from the Authentication server (step 10) with the IMS identity (IMPI and IMPU associated) and the Secret Key to perform successfully the registration procedure. This response is sent over an Identity Reservation Answer message (IRA) as a response to the IRR message of step 10.

The DIAMETER Identity Reservation Answer message is NOT part of the DIAMETER standard and is proposed in this patent proposal as one of the innovative aspects that can be associated to a standard. The DIAMETER messages contain information elements or AVPs (Attribute-Value Pairs). The AVPs that the Identity Reservation Answer (IRA) should contain at least are the following:

```
<IRA> ::= < Diameter Header: ddd, PXY >
    < Session-Id >
    { Auth-Application-Id }
    { Result-Code }
    { Auth-Session-State }
    { Origin-Host }
    { Origin-Realm }
    [ User-Name ]
    [ SIP-AOR ]
    [ SIP-Number-Auth-Items ]
  * [ Identity-Data-Item ]
    [ Authorization-Lifetime ]
    [ Auth-Grace-Period ]
    [ Redirect-Host ]
    [ Redirect-Host-Usage ]
    [ Redirect-Max-Cache-Time ]
  * [ Proxy-Info ]
  * [ Route-Record ]
  * [ AVP ]
```

The Identity-Data-Item AVP is optional and carries the requested identity information, generated by the HSS. This AVP would be a grouped set of AVPs and would contain the following AVPs as well:

```
<Identity-Data-Item> ::= < AVP Header: XYZ >
  1* { IMPI }
  1* { IMPU }
  1* { Secret-Key }
```

The AVP IMPI will carry the IMPI identity provided by the HSS. The AVP IMPU will carry the IMPU identity generated by the HSS. The AVP Secret-Key will contain the secret key generated in real time by the HSS for the previous IMPI and IMPU.

The header values XYZ used throughout the flow description would be defined by IANA during a formal standardization procedure.

13. Authentication Server forwards that information to the UE. That information is securely protected with standard mechanisms.

14. Once the UE has received the IMS identity details as well as the secret key, a standard registration procedure in IMS can start. That is started with a SIP REGISTER sent from the UE to the P-CSCF.

15. The UE performs a full registration against the S-CSCF (the SIP registrar), using the identity and Secret Key provided by the Authentication server to do so. The procedures to perform this registration are standard and specified by 3GPP.

16. When the UE is fully registered, the S-CSCF sends a SIP 200 OK to the UE informing about the successful registration. The HSS has marked the IMPU and IMPU as registered. Accordingly, they will not be used in another registration procedure.

17-20. Once the UE has been fully registered in the IMS domain, the UE will be able to access the functionality provided by the AS IMS. In order to do that, several mechanisms supported by SIP protocol can be used. Multimedia sessions established by a SIP INVITE, a SIP MESSAGE and some others. The specific procedure followed by the UE to get the functionality provided by the AS IMS is not critical for the current patent submission, and any standard procedure supported by IMS and SIP is valid.

21. Once the UE does not need the resources provided by AS IMS any more, or when some security time has passed, the UE is deregistered from the IMS control layer. In order to do so, standard procedures specified by 3GPP are used.

22. While the UE (with IMPI and IMPU temporarily assigned) is being deregistered, the HSS is notified about that.

23. The HSS marks the IMPI and IMPU as available for other temporary registration request from the Authentication Server. In addition, the Secret Key associated to the IMPI and IMPU is generated again for security reasons.

24. The UE is finally deregistered from the IMS control layer.

25. The UE cleans the internal memory records of the IMS identities and credentials.

The header values XYZ used throughout the flow description would be defined by IANA during a formal standardization procedure.

The innovative parts of the present invention, for different embodiments, are the following:
Authentication Server Web-IMS. This element validates the identity of the user via a web-based username/password and once that is done, interacts with the HSS to get the IMS identity and registration credentials.
Interface Authentication Server—HSS. This interface is based on DIAMETER protocol, although some other mechanisms with the same functionality are also valid. The standard DIAMETER protocol is extended with two additional primitives that would be added to the standard:
   Identity-Reservation-Request (IRR).
   Identity-Reservation-Answer (IRA).
Internal data structure of the HSS; that reserves a set of identities of a pool to be assigned on demand for requests from the Authentication Server. The HSS will also update the Secret Key after each identity (IMPI, IMPU) is used.
Reservation mechanism at the HSS. The HSS would include a mechanism to reserve an identity from the pool when an IRR message is received, and assigns that identity to the user-name and web-token included in the IRR message. That identity is made available again when the IMS de-registration procedure (standard mechanism) is executed.

### Use Case:

In order to present clearly the idea behind the invention, a use case is briefly next described:

A user's context information manager is deployed in a convergent IMS service layer. That means that can only be accessed via an IMS control layer with a proper IMS identity provisioned both in the User Equipment as well as in the HSS. Eventually, some user needs to upload some context-status reports to the context manager application server, but the UE of the user has no IMS client embedded.

In order to be able to upload the information, the UE makes use of this particular proposal and uploads the information to the AS IMS, or gets specific reports provided by the AS IMS.

It is especially suitable for M2M and ubiquitous context-aware deployments in which it is not optimum to provision an IMS identity in the HSS for all the UEs deployed, or it is very difficult to configure those identity parameters in the UEs. That may be the case in the scenarios in which the devices need to access the AS IMS (to generate information to upload or to get reports from the AS) not very often in time.

In these scenarios, the deployment of such architecture is much simpler with this proposal, minimizing the costs and technical complexities involved.

### ADVANTAGES OF THE INVENTION

The UEs or devices that do not have an IMS identity preconfigured (which is likely to happen in most situations), can access AS IMS/IMS Enablers via the assignment of a temporary IMS identity.
Even though the identity used to access the IMS domain is a pooled one, the user can still be traced due to the web-token provided by the Authentication server, validated with a user credential provided by the Identity provider via HTTP-based authentication protocols.
The user will see a seamless behaviour, as the authentication of the user is performed via a SSO procedure. If the user has logged previously against the IdP (SSO service), the user will not need to enter any password, and all the process will be mostly transparent to the user.

A person skilled in the art could introduce changes and modifications in the embodiments described without departing from the scope of the invention as it is defined in the attached claims.

### ACRONYMS AND ABBREVIATIONS

AVP ATTRIBUTE-VALUE PAIR
HSS HOME SUBSCRIBER SERVER
HTTP HYPERTEXT TRANSFER PROTOCOL
I-CSCF INTERROGATING-CALL SESSION CONTROL FUNCTION SERVING
IETF INTERNET ENGINEERING TASK FORCE
IMPI IP MULTIMEDIA PRIVATE IDENTITY
IMPU IP MULTIMEDIA PUBLIC IDENTITY
IMS IP MULTIMEDIA SUBSYSTEM
IdP IDENTITY PROVIDER
IP INTERNET PROTOCOL
IRA IDENTITY RESERVATION ANSWER
IRR IDENTITY RESERVATION REQUEST
MAA MULTIMEDIA AUTHENTICATION ANSWER
MAR MULTIMEDIA AUTHENTICATION REQUEST
P-CSCF PROXY-CALL SESSION CONTROL FUNCTION SERVING
RACS REQUEST ASSERTION CONSUMER SERVICE
S-CSCF SERVING-CALL SESSION CONTROL FUNCTION SERVING
SAML SECURITY ASSERTION MARKUP LANGUAGE
SIP SESSION INITIATION PROTOCOL
SSO SINGLE SIGN ON
UE USER EQUIPMENT
UMTS UNIVERSAL MOBILE TELECOMMUNICATIONS SYSTEM
URI UNIFORM RESOURCE IDENTIFIER
XDSL X-DIGITAL SUBSCRIBER LOOP
XHTML EXTENSIBLE HYPERTEXT MARKUP LANGUAGE
XML EXTENSIBLE MARKUP LANGUAGE

### REFERENCES

[1] IETF RFC 3588 “Diameter Base Protocol”
[2] 3GPP TS 33.203 “Access security for IP-based services”
[3] 3GPP TS 23.228 “IP Multimedia Subsystem (IMS)”

[4] N. Ragouzis et al., Security Assertion Markup Language (SAML) V2.0 Technical Overview. OASIS Committee Draft, March 2008.

1-18. (canceled)

19. A method for IMS control layer authentication from external domains, comprising obtaining, a user equipment (UE) a first set of IMS credentials from a network element (40) via a HTTP-based mechanism in order to:
i) obtaining for a user, an authentication registrar (S-CSCF) of a IP Multimedia Subsystem, or IMS, control layer, said first set of IMS credentials from said user equipment (UE) and a second set of IMS credentials from a Home Server Subscriber, or HSS (100); and
ii) said authentication registrar (S-CSCF) comparing said first and second sets of IMS credentials, and depending on the result of said comparison granting or denying the access of said user to IMS services,
characterised in that said network element (40) is an authentication server (40), said method further comprising validating the identity of said user by means of said authentication server (40) via said HTTP-based authentication mechanism as a condition to provide the user with said IMS credentials, by means of said authentication server (40).

20. A method as per claim 19, comprising said authentication server (40), once the identity of said user has been validated, obtaining the first set of IMS credentials from said HSS (100).

21. A method as per claim 20, comprising performing said obtaining of said first set of IMS credentials also via a HTTP based mechanism.

22. A method as per claim 21, comprising using a secure protocol to perform said obtaining of said first set of IMS credentials via said HTTP based mechanism.

23. A method as per claim 22, wherein said secure protocol is DIAMETER protocol.

24. A method as per claim 22, wherein said obtaining of said first set of IMS credentials using said secure protocol comprises the authentication server (40) querying the HSS (100) for the first set of IMS credentials via an Identity Reservation Request message, or IRR message.

25. A method as per claim 24, wherein said obtaining of said first set of IMS credentials using said secure protocol comprises the HSS (100) responding to said IRR message with an Identity Reservation Answer message, or IRA message, including said first set of IMS credentials.

26. A method as per claim 25, comprising the HSS (100) retrieving said first set of IMS credentials by selecting an available IMS identity out of a pool of IMS identities stored therein.

27. A method, as per claim 19, wherein said IMS credentials comprise: a IP Multimedia Private Identity, or IMPI, a IP Multimedia Public Identity, or IMPU, and a secret key.

28. A method as per claim 27, wherein said IMS identities of said pool are identified by IMPI/IMPU pairs with respective associated secret keys, the method comprising updating said secret keys every time an IMPU/IMPI combination is used by a user agent to register to the IMS control layer.

29. A method as per claim 19, comprising said user equipment (UE) deleting the first set of IMS credentials once is finally deregistered from the IMS control layer.

30. A method as per claim 29, comprising notifying the HSS (100) of the deregister of said user equipment (UE) and marking, the HSS (100), the IMPI/IMPU pair of the first set of credentials as available for other temporary registration request from the authentication server (40) and generating and associating thereto a new secret key.

31. A method as per claim 19, comprising:
requesting, the user equipment (UE), said first set of credentials to said authentication server (40);
responding, the authentication server (40), to the user equipment (UE) with an XHTML form that includes a token to track the transaction;
requesting, the user equipment (UE), a Single Sign-On Service, or SSO service, at an Identity Provider, or IdP, said request including sending said token;
responding, said IdP, to the user equipment (UE) with an XHTML form, validating the request, said response including a security assertion;
sending, the user equipment (UE), a Request Assertion Consumer Service, or RACS, to the authentication server (40) including said security assertion;
processing, the authentication server (40), said RACS, creating a security context at the service provider and redirecting the user equipment (UE) to the target resource;
requesting, the user equipment (UE), the resources to the authentication server (40), after the said redirection; and
the authentication server (40) performing said validation of the identity of the user by using a username/password available in the SSO service at the IdP for said user equipment (UE).

32. A system for IMS control layer authentication from external domains, comprising at least:
a user equipment (UE);
a HSS (100);
an authentication registrar (S-CSCF) of a IMS control layer; and
first communication means (120, 30, 190, 150; 170) connecting said authentication registrar (S-CSCF) with said user equipment (UE) and with said HSS (100);
where said authentication registrar (S-CSCF) is intended for comparing two sets of IMS credentials for a user: a first set from a user equipment (UE) and a second set from said HSS (100), obtained through said communication means (120, 30, 190, 150; 170), and for, depending on the result of said comparison, granting or denying the access of said user to IMS services;
wherein said system is characterised in that it further comprises an authentication server (40) communicated, through second communication means (120, 30, 130), with said user equipment (UE) for providing it with said first set of IMS credentials via a HTTP-based mechanism.

33. A system as per claim 32, wherein at least said user equipment (UE), said HSS (100), said first (120, 30, 190, 150; 170) and second (120, 30, 130) communications means and said authentication registrar (S-CSCF) are arranged for implementing the following method for IMS control layer authentication from external domains:
i) obtaining for a user, an authentication registrar (S-CSCF) of a IP Multimedia Subsystem, or IMS, control layer, said first set of IMS credentials from said user equipment (UE) and a second set of IMS credentials from a Home Server Subscriber, or HSS (100); and
ii) said authentication registrar (S-CSCF) comparing said first and second sets of IMS credentials, and depending on the result of said comparison granting or denying the access of said user to IMS services;
wherein said network element (40) is an authentication server (40), said method further comprising validating the identity of said user by means of said authentication server (40) via said HTTP-based authentication mechanism as a condition to provide the user with said IMS credentials, by means of said authentication server (40).

34. A system as per claim 33, further comprising third communication means (14) connecting said authentication server (40) with said HSS (100) for obtaining the first set of IMS credentials from said HSS (100) according to the method in which said authentication server (40), once the identity of said user has been validated, includes obtaining the first set of IMS credentials from said HSS (100).

35. Network element for IMS control layer authentication from external domains, characterised in that it comprises:
IMS communication means for communicating with an HSS (100) for obtaining a first set of IMS credentials there;
HTTP-based communication means for communicating with a user equipment (UE) via a HTTP-based mechanism for at least providing it with said first set of IMS credentials; and
processing means for at least performing processing tasks needed for said obtaining and providing of said first set of credentials;
wherein the network element (40) is arranged for implementing the following method for IMS control layer authentication from external domains:
i) obtaining for a user, an authentication registrar (S-CSCF) of a IP Multimedia Subsystem, or IMS, control layer, said first set of IMS credentials from said user equipment (UE) and a second set of IMS credentials from a Home Server Subscriber, or HSS (100); and
ii) said authentication registrar (S-CSCF) comparing said first and second sets of IMS credentials, and depending on the result of said comparison granting or denying the access of said user to IMS services;
wherein said network element (40) is an authentication server (40), said method further comprising validating the identity of said user by means of said authentication server (40) via said HTTP-based authentication mechanism as a condition to provide the user with said IMS credentials, by means of said authentication server (40).
